(19) United States
(12) Patent Application Publication
(10) Pub. No.: US 2002/0042808 A1
(43) Pub. Date: Apr. 11, 2002

(54) Method and apparatus for linking data and objects

(76) Inventors: Joshua R. Smith, Cambridge, MA (US); Paul Michael Yarin, Cambridge, MA (US); Michael J. Murphy, Salem, NH (US); Andrew Victor Sutherland II, Concord, MA (US)

Correspondence Address: CESARI AND MCKENNA, LLP, 88 BLACK FALCON AVENUE, BOSTON, MA, 02210, US

(21) Appl. No.: 09/865,889

(22) Filed: May 25, 2001

Related U.S. Application Data
(60) Provisional application No. 60/236,976, filed on Sep. 29, 2000.

(51) Int. Cl. G06F 7/00

(52) U.S. Cl. 709/1; 709/100

(57) ABSTRACT

A method and apparatus for linking data objects and physical objects of various kinds for a user is described. A particularly useful application of such linkage associates a user identifier with one or more physical addresses to which the user wishes to direct the delivery of the physical objects. Different types of objects may be directed to the same or different addresses, and the association can be changed partly or wholly by the user when desired.

### CROSS-REFERENCE TO RELATED APPLICATIONS

The present application claims priority from U.S. Provisional Patent Application Serial No. 60/236,976, which was filed on Sep. 29, 2000, by Michael J. Murphy, Joshua R. Smith, Paul Michael Yarin, and Andrew Victor Sutherland II for “Method And Apparatus For linking Data And Objects”, and is hereby incorporated by reference in its entirety, including attachments thereto.

### BACKGROUND OF THE INVENTION

1. Field of the Invention

The invention relates to methods and apparatus for linking data objects of varying kinds, whether electronic or physical or both.

2. Background Information

As data of various kinds increasingly drives modern society, data storage and retrieval have become increasingly complex, but essential, aspects of business operations. Issues such as data privacy, data redundancy, and data conversion have come to play a larger role in such operations, and efforts to facilitate efficient data usage are essential.

### SUMMARY OF THE INVENTION

In our related and earlier provisional application entitled “Associating Electronic Data Object With Physical Object”, U.S. Patent Application Serial No. 60/236,976, filed Sep. 29, 2000, the contents of which are expressly incorporated herein by reference, and the priority date of which is hereby expressly claimed, we described methods and apparatus for linking data objects (such as information stored in various forms in a computer, information printed on a circular, an envelope, a barcode label, etc.) and physical objects (e.g., an envelope, a package, etc.) of various kinds. Among the functionalities described was one which enables users to monitor, modify, and utilize data relating to physical objects to be delivered to them, including particularly the delivery of mail. The present application is directed to that invention.

### BRIEF DESCRIPTION OF THE DRAWINGS

The invention description below refers to the accompanying drawings, of which:

FIGS. 1-10 are screen snapshots of a graphical user interface that is useful in accordance with the invention;

FIG. 11 is a block and line diagram of an environment in which the system of invention may advantageously operate.

### DETAILED DESCRIPTION OF AN ILLUSTRATIVE EMBODIMENT

The present invention is particularly directed to methods and apparatus for facilitating the accurate delivery of mail, by which is meant to include letters, catalogs, newspapers, magazines, and physical objects of all kinds. It is expected to be of especial use as part of a Postal System such as the United States and other postal offices, although it is not so limited and has numerous other applications as will be apparent on reading the following detailed description.

As will be seen from the detailed description of a specific embodiment herein, the system enables the association with an entity such an individual, a business, an organization, etc. an identifier by which the entity may be addressed and from which the physical location to which an object is to be delivered is readily ascertained. The entity can, from time to time, change the physical location for delivery, while retaining the same identity. Thus, its “address” can be maintained current, even when it frequently changes. Further, the entity can establish different delivery addresses for different types of objects, and can readily change these addresses as circumstances require. The invention is best explained by means of various screens by which the entity receives information concerning the types and status of objects being directed to it, and by means of which it can readily modify the delivery process.

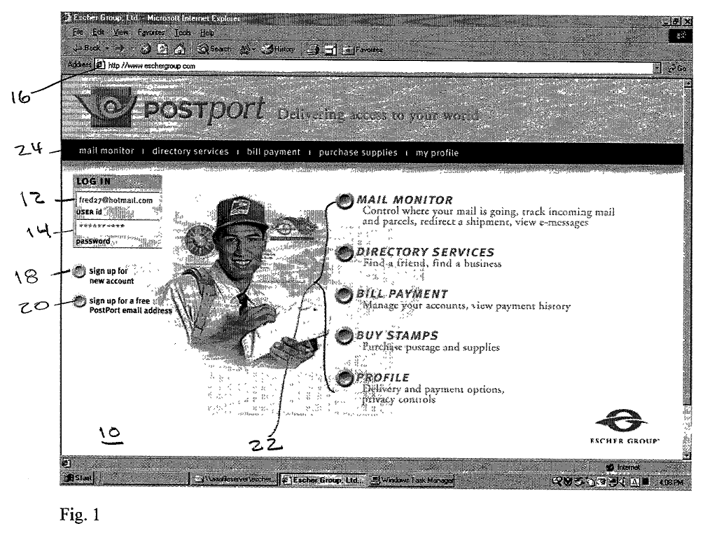

In FIG. 1, an introductory screen 10 of an exemplary graphical user interface that may be used in accordance with the present invention is shown. The screen is displayed, e.g., on the video monitor of a computer connected to a computer network such as, but not limited to, the Internet and summarizes the services that may be accessed from the screen by the user. In the present instance, five such services are provided, namely, mail monitor; directory services; bill payment; purchase supplies (e.g., buy stamps); and my profile. These will be explained in detail below.

The screen 10 contains an area 12 for entry of a User ID and an area 14 for entry of a User Password. The User ID and User Password control access to the services to be provided. The User ID may comprise, for example, the e-mail address of the user as assigned by a provider of access to the internet or by some other person or entity; the User Password is preferably chosen by the user himself or herself. An address area 16 displays the address of the site on the Internet to which the user is connected, in this case, the site that is providing the desired services. The site is, for example, initially accessed in the usual manner, i.e., by entering the web address in a browser and pressing “Return” on a keyboard, or by clicking on a link to the web address that is presented, e.g., on a video display. “Button” 18 enables the user to sign up for a new account on the system, and button 20 enables the user to sign up for an email address on the system, here referred to as the “PostPort” system. Buttons 22 enable the user to access the various services. These buttons are preferably activated simply by clicking on them. The services may alternatively be activated by clicking on the corresponding label in a menu bar 24.

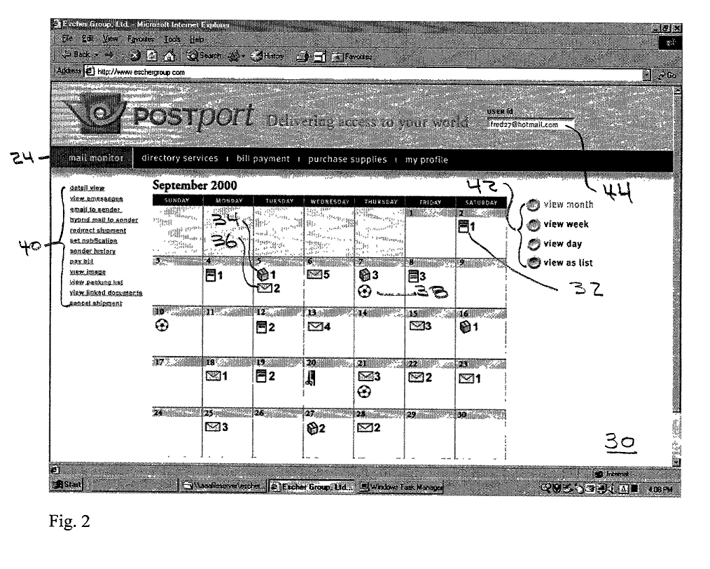

FIG. 2 shows an exemplary calendar screen 30 which displays icons associated with particular tasks or events. For example, an icon 32 indicates that a periodical publication is expected to arrive on September 1. Icons 34 and 36 indicate that on September 5, a package (icon 34) and a letter (icon 36), respectively, were, or are scheduled to be, received. The icons represent data objects which themselves may have further information associated with them and with respect to which various actions may be taken. For example, letter icon 36 may have associated with it data describing the source of the letter, the nature of the letter (e.g., bill, circular, personal, etc.), deadlines associated with the letter (e.g., the last data on which the bill contained in the letter may be paid without penalty), etc. The data objects are not restricted to the sending and receiving of mail, and may include notice of events of timely interest. For example, an icon 38 indicates that on September 7, there is to be a soccer game. The icons may be displayed at the initiation of the user (e.g., as a reminder to self) or by a third party who wishes to communicate with the user by causing display of a data object to the user.

A menu 40 enables the user to perform selected actions with respect to the data objects presented in the calendar and thus also with respect to any underlying physical object that they may represent. Among these are “detail view” which enables the user to access further information concerning the object, such as the nature of the object, deadlines associated with it, etc. as described above; “view messages” which enables the user to view a list of electronically transmitted messages; “email to sender” which enables the user to quickly send an email to the sender of the data object; “hybrid mail to sender” which, e.g., allows mail to be sent along one part of its route in electronic form and along another part in physical form; “redirect shipment”, which enables the user to forward the object to another address; “set notification” which enables the user to configure alerts such as pager messages that depend upon message sender, content, or time; “sender history” which enables the user to access information concerning the sender, such as prior data objects sent, when sent, etc.; “pay bill” which enables the user to pay received bills electronically; “view image” which enables the user to view an image of the object that has been scanned into or otherwise placed in the database of data objects; “view packing list” which enables the user to view a list of the physical contents of a parcel shipment, “view linked documents” which enables the user to view documents that are associated with a particular data object; and “cancel shipment” which enables the user to cancel a shipment of the object, e.g., a package. The user may perform any of these actions simply by selecting a data object, such as by clicking on it, and then selecting the desired functionality from the menu 40, also by clicking on it. Additionally, buttons 42 enable the user to present the calendar view as a monthly view, a weekly view, a daily view, or as a list. The user is identified in a display slot 44, and actions taken with respect to a data object implicitly reference the data associated with that user. Menu 24 allows the user to select a different functionality, e.g., “mail monitor”, “directory services”, “bill payment”, etc. as noted above.

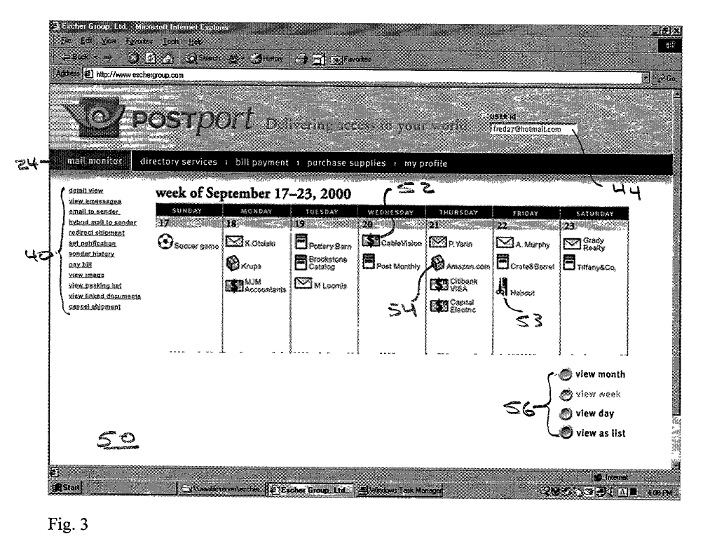

FIG. 3 is an example of a screen 50 with an expanded (e.g. weekly) calendar. In this screen, additional information is presented directly with respect to the various data objects. Thus, a data object 52 is presented as an envelope with a “$” sign through it to indicate that a bill is being presented to the user for payment on the date indicated; the sender of the object is also identified in association with the object, e.g., beside it. In the example illustrated, the sender of data object 52 is “CableVision”. Other data objects notify the user of other events, e.g., a scheduled haircut on Friday, indicted by data object 53 or expected or actual receipt of a package on Thursday, indicated by data object 54. As was previously the case, a menu 40 and buttons 56 allow the user to obtain further information, or to take particular actions with respect to, the indicated objects.

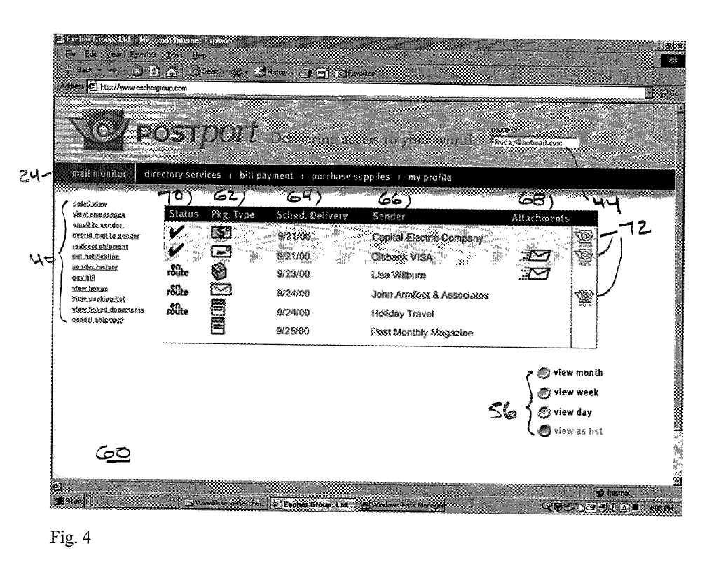

FIG. 4 shows a screen 60 that provides a different level of detail concerning various data objects. In this screen, selected information concerning objects to be delivered during a given time period is presented. The user can access this view by selecting “view as list” from the previous screen 50 (FIG. 3). Thus, information concerning objects scheduled for delivery during, e.g., the period between September 21-25 are identified by object type (62), scheduled delivery date (64), sender (66), attachments (68), and status (70). Status indicators 72 indicate that the postal service has electronically authenticated the identity of the payee, thus protecting the user from fraudulent charges. In response to the information thus presented, the user may decide to take various actions, e.g. “pay bill”, “cancel”, “redirect shipment”, etc. as provided in menu 40 and discussed earlier.

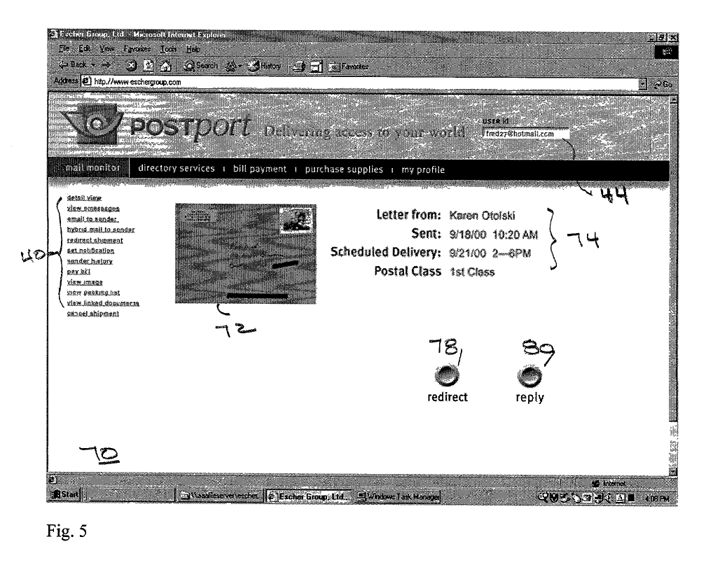

FIG. 5 shows a screen 70 that provides an image 72 of the object, together with further information 74 concerning it. Given this information, the user may take one or more of the actions identified in menu 40. Additionally, depending on the nature of the object, buttons such as buttons 78 and 80 may be provided to enable rapid action concerning the object. For example, in the case of personal correspondence, the object may be redirected to another address (e.g., to a spouse, to a child, to the private residence of the user, etc.) simply by clicking on button 78; or a word processor or other program may be activated to enable reply simply by clicking on a button 80.

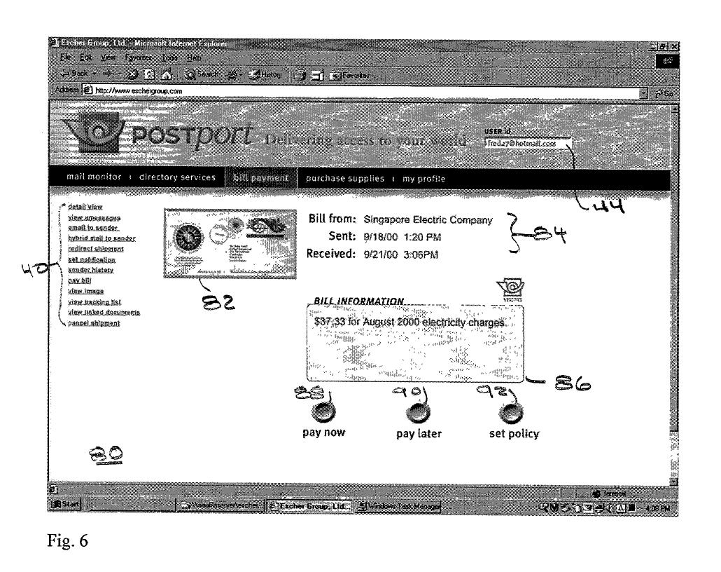

FIG. 6 shows a bill payment screen 80 in which different elements of information and different response choices are presented to the user responsive to the presentation of a different type of data object. In screen 80, the image of a data object 82 comprising a bill is presented to the user. The source of the bill, the date it was sent and the date it was received is presented at 84 and the amount of the bill is shown at 86. This information is provided by the sender and is associated with the data object in the system. It may be an amount that is unique for each new bill presentation, or it may be a predefined default value. Buttons appropriate to the data object enable the user to direct that the bill be paid now (button 88), paid later (button 90), or paid in accordance with a predefined policy (e.g., 30 days after presentation) (button 92) simply by clicking on them with a mouse. The policy is established by the user and may be associated with the data object in various ways, e.g., “associate with all bills”, “associate with bills from a particular vendor”, etc.

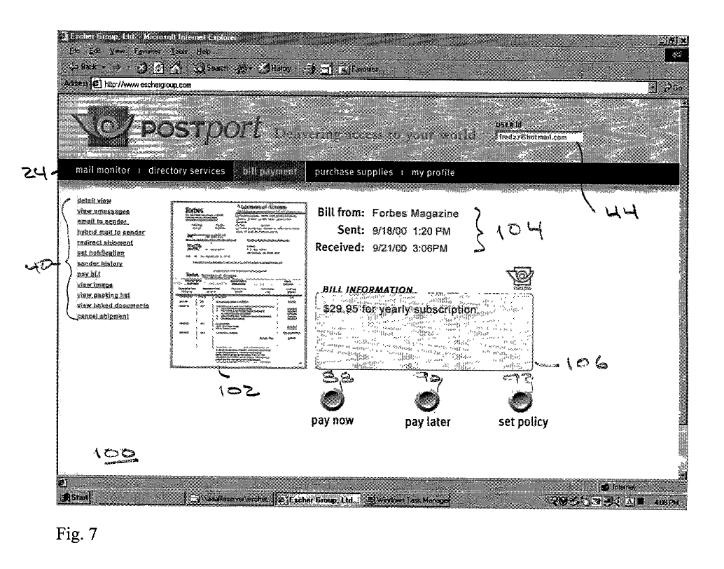

FIG. 7 illustrates a bill payment screen 100 in which more detailed information concerning a bill is presented by means of its image 102. As shown, the image 102 comprises a detailed invoice from a vendor identified in field 104; the latter also shows the dates of transmission and reception of the bill. A summary of the bill, in the instant example merely stating the amount due, is presented in field 106. Menu buttons 88-92 enable the user to respond to the data object as previously described.

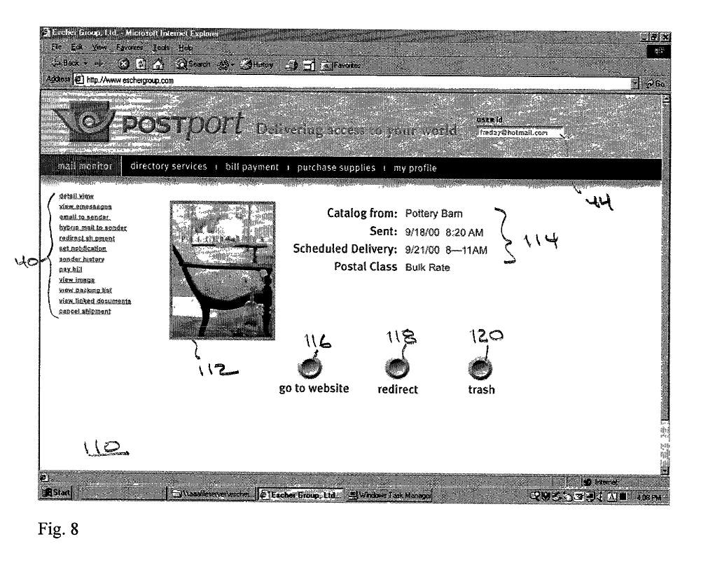

In FIG. 8, a screen 110 indicates transmission of a catalog (image 112). The source of the catalog and its transmission and scheduled delivery dates are shown at 114, together with the mode of shipment (“postal bulk rate”). Buttons are provided to enable the user to quickly view a website associated with the shipper (button 116); to redirect the shipment to another address (button 118); or to inform the sender or a carrying authority (button 120, “trash”) that receipt of the item is not desired Alternative actions may be selected from menu 40 as was the case with prior screens.

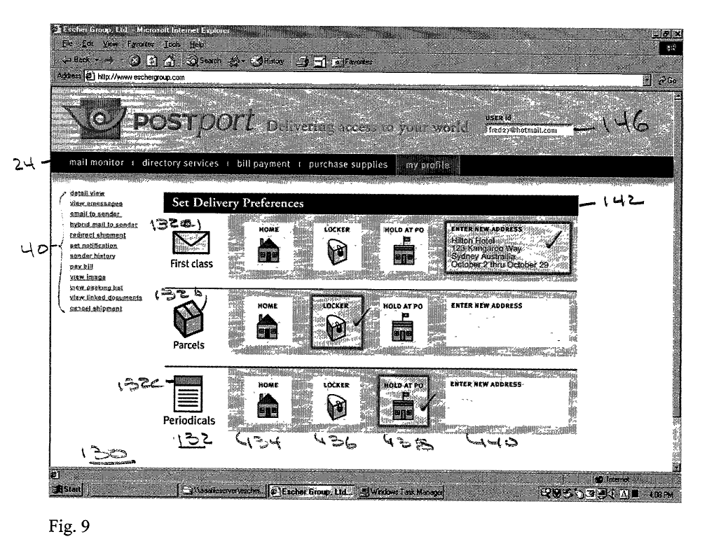

FIG. 9 shows a screen 130 that enables the user to configure preferences for delivery. Column 132 contains icons 132a, 132b, 132c identifying data objects comprising, e.g., first class mail (132a), parcels (132b), and periodicals (132c), respectively; other types of data objects may, of course, be included. Columns 134, 136, 138, and 140, respectively, identify sites or addresses to which the objects of a given object class are to be redirected. For example, column 134 contains “home” icons that identify the home address of the user as the site to which the object is to be directed or redirected; column 136 contains “locker” icons that specify a facility (e.g., a “lockbox”) to which the object is to be directed or redirected; and column 138 contains “hold at PO” icons that identify the user's Post Office as the site to which the objects are to be directed or redirected. (For simplicity, hereinafter the terms “direction” or “directed” will be used to indicate either the initial selection of a delivery location (“direction”), or a subsequent change in this location (“redirection”), or both).

Column 140 allows the user to enter a specific address that may differ from one of the preset addresses of columns 134-138. For example, a home address may previously have been set for delivery of mail of all types. When the user is about to go on a business trip, for example, he or she may desire to have first class mail forwarded to the address of a hotel at which he or she will be staying until his or her return; to have parcels held in a locker; and to have periodicals held at the local Post Office. This is accomplished simply by clicking on the “Enter New Address” icon in column 140 in the “First Class” mail row 132a and by entering the address of the hotel; by clicking on the “Locker” icon in column 136 in the “Parcels” mail row 132b; and by clicking on the “Periodicals” icon in column 138 in the “Periodicals” mail row 132c. The chosen preferences are desirably then indicted by a checkmark or other indicia, as shown in FIG. 9. These preferences may remain until subsequently changed, or may default to a user-defined configuration after a certain time period; or a sequence of addresses and associated time periods may be provided for the various data objects.

As was previously the case, additional actions with respect to the data objects of FIG. 9 may be taken by selecting one or more items from the menu 40. Thus, data objects or physical objects directed to a user who may be identified only by his or her email address 146 can efficiently be received by that user and/or directed by that user to other desired locations. This enables a user to maintain privacy with respect to certain object-originating sources while still receiving objects and communications from that source, as well as from others, without interruption or delay. The user direction mappings may also be made time-dependent, so that they direct objects to a first location during a first time period, to a second location during a second time period, etc.

The direction facility is a particularly powerful feature having many applications. For example, by using the user's email address or some other agreed upon identifier or set of identifiers that is capable of uniquely identifying an individual (i.e., a personal postcode) as the address for an object, instead of using an address that once might have been correct but that has since been changed, the likelihood that the object will reach the intended recipient is greatly increased, at least for users who maintain their preferences current, since the latest specified physical address/location of the user can readily be retrieved at any step of the delivery process and can be used for the physical delivery. Alternatively, the sender may arrange to access the user database in order to ascertain the current address to which to direct an object. The access may be made directly by the sender, preferably based on the user's person postcode but alternatively based on other unique identifiers such as name, address, etc. Alternatively, an entity such as a postal service that is to transport the object to the user may perform the access and itself apply the address or routing information to the object in connection with its carriage. Either approach would greatly reduce the cost of delivery of objects that might otherwise have carried a physical address that once was valid but that no longer is. Note that the “binding” of the personal postcode to the physical postcode can be performed either “late” (the personal postcode maps to a physical address, which only later is associated with the physical postcode) or “early”, at the time that the association between the personal postcode and the physical address is established.

Within a postal service the redirection facility can also increase efficiency of sorting and routing. There are several possible embodiments of the mailing process. In one embodiment, the mailer searches a postal database for the physical address associated with a personal postcode. In a second embodiment, the mailer retrieves the physical address and physical postcode from the postal database. In a third embodiment, the mailer retrieves only the physical postcode from the postal database. The personal and/or physical postcodes may be printed in human and/or machine readable form (OCR-able characters, one or two dimensional barcodes, or other symbologies, including watermarks).

Similarly, there are several possible embodiments of the mail sorting process. In one embodiment of the sorting process, the personal postcode is read from the mailpiece by a machine early in the sort process. The associated physical address or physical postcode may be printed on the mailpiece (in human and/or machine readable form) early in the sorting process, and read by other sorting equipment later in the sorting process. In another embodiment, the personal postcode is read at each stage of sorting, and the physical postcode is retrieved from a database at each stage to make the necessary sorting decisions. The advantage of this approach is that nothing need be printed on the mailpiece. The disadvantages are that more database access is required, which has a cost in time and money, and the final mailpiece does not have any human readable indication of the true destination address.

Since the final stage of the sorting process is, typically, delivery by a human being, it is usually desirable to have some human-readable indication of the desired destination delivery point printed on the mailpiece in human readable form (the physical postcode may be enough; the explicit address may not be required as the postal delivery person typically knows the mapping from physical postcodes to physical addresses). The human-readable indication of the physical postcode may not absolutely necessary, however, as the mailpieces may be automatically sorted in carrier delivery route order, in which case their position in the delivery person's stack of mail, plus the human readable name or personal postcode, would serve to allow the postal delivery person to infer the correct delivery location even if the human-readable physical address or physical postcode on the mailpiece is absent or incorrect. In another embodiment, the postal delivery worker may use a device capable of looking up the physical delivery location when provided with the personal postcode (either manually by the delivery person, or by an OCR scan, or by a scan of a machine readable representation of the personal postcode from the mailpiece).

Additional aspects of the system include the ability of individuals to find out who has queried the postal database to find out their physical address. This feature is analogous to both the logfiles generated by web servers and to the “Caller ID” system for telephone communications. Such features empower the subject of public communications and queries as they (1) make evident the underlying operation of the system, (2) provide traceability and accountability (for example, as a precedent to restricting communications), and (3) discourage harassment or destructive use of the communications system. When there is no physical address on record, the postal authority can contact the individual by email, if email addresses are used as personal postcodes.

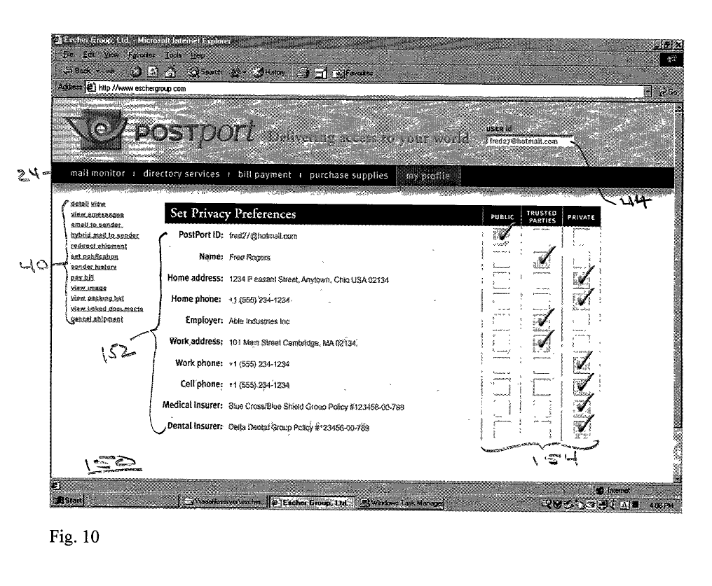

Finally, in FIG. 10, a screen 150 is provided to enable the user to set desired privacy preferences. User information details 152 such as, e.g., the User ID (“PostPort ID”), Name, Home address, Home phone, employer, work address, work phone, cell phone, medical insurer, and dental insurer of the user may be categorized into varying levels of restriction 154, such as “Public”, “Trusted parties”, “Private”, etc. by checking the privacy group level 154 corresponding to the particular item of information as illustrated in FIG. 10. These may, of course, be changed by the user when desired.

The methods described herein are readily implemented using, e.g., conventional file servers and personal computers, although more powerful computers can, of course, be gainfully employed. The user database is readily prepared using conventional database software such as that supplied by Oracle, Microsoft, and IBM, among others, or by software such as the Escher Group's WebRiposte™ for web-based applicaitons. Communications between users of the system and the hardware components thereof may utilize any form of electronic communication, such as direct wire, wireless, modems, and the Internet, among others.

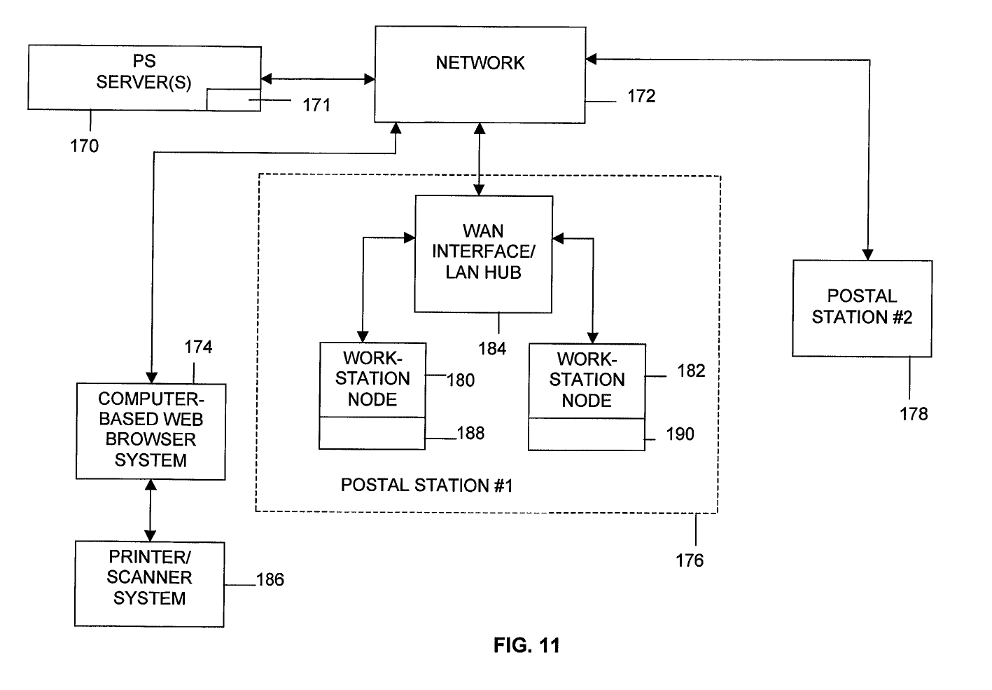

FIG. 11 illustrates an environment in which the system of FIGS. 1-10 is advantageously used. In FIG. 11, a Post Office server 170 is connected via a network such as the Internet 172 to a number of web browsers 174 (for simplicity, only one such browser is shown but it will be understood that that number of browsers to be used is potentially unlimited), as well as to one or more postal stations 176, 178. Each postal station contains one or more work stations 180, 182 which may be interconnected by a network 184. If desired, printer/scanners 186-190 may be attached to the workstations to enable scanned input and hard-copy output at the browsers. Browser 174 may be located in the home or office of an individual; browsers 180, 182 are located at the various postal service stations maintained by the Post Office, and are made available to individual users.

The Postal Server may comprise a single server, or be one of a plurality of such servers, preferably interconnected for sharing data. Associated with each server is a database 171 on which the identity and other pertinent data such as physical (i.e. street) address, email address, unique identifier, telephone number, mail delivery preferences and other such data with respect to each of its customers is stored. The Postal Service itself may use access this database to obtain the current address of a customer for delivery of the physical mail in the case of mail that is found to have been misdirected or returned for insufficient or incorrect address. It may also access this database in order to ascertain the correct current address of a customer in the first instance. For example, third parties wishing to send mail to then customer may simply address the mail with the customer's unique Postal Identifier if one has been provided to the third party, or by means of the customer's email address, or by some other identifier or combination of identifiers corresponding to data associated with that customer in the database 171 and which uniquely identifies that customer. The Postal Service can then retrieve the physical address of that customer for delivery of the physical item to it, and may additionally provide notification to the customer concerning the item being sent as described in detail above. Alternatively, the Postal Service may, under suitable conditions, provide access to its database directly to the third party, which may then retrieve the necessary data for sending physical mail to the customer.

The customer itself may employ the linkage system of the invention from his or her home (e.g., via the web browser 174) from a postal station 176, 178. Thus, wherever the individual travels in a country providing this facility, he or she can direct the delivery of mail as desired, and can change this direction as appropriate.

What is claimed is:

1. A method of effectuating the delivery of mail to an entity, comprising:
A. obtaining an identifier associated with said entity for delivery of mail,
B. from a database which stores a plurality of sets of (entity-identifier-delivery location) relationships and which is accessible to retrieve at least one element of the set given at least one other element of the set, using said identifier to retrieve an address at which said mail is to be delivered to said entity, and
C. using said address to effectuate delivery of said mail.

2. The method of claim 1 which inlcudes a database which stores a plurality of sets of (entity-identifier-delivery location) relationships and which is accessible to retrieve at least one element of the set given at least one other element of the set.

3. The method of claim 2 in which said database is associated with a Postal Service facility and is accessible by or through said facility.

4. The method of claim 2 in which said database includes a first plurality of types of mail and a second plurality of delivery locations for at least one of said entities.

5. The method of claim 4 in which the relationships between the mail types and the delivery locations associated with an entity may be changed by said entity.

6. The method of claim 5 in which the temporal duration of the relationships between said object types and said delivery locations may be established and changed by said entity.

7. The method of claim 5 which includes a graphical interface connected to notify an entity of mail addressed to said entity.

8. The method of claim 5 in which said interface is configured to display icons indicating different types of mail addressed to said entity.

9. The method of claim 8 in which said interface is configured to display dates associated with said mail.

10. The method of claim 9 in which said interface is configured to display the date said mail was logged into a postal delivery system.

11. The method of claim 9 in which said interface is configured to display the date on which delivery of said mail is expected to occur.

12. The method of claim 8 in which said interface is configured to display the date on which delivery of mail was made.

13. The method of claim 7 in which said interface is configured to display information concerning the source of said mail.

14. The method of claim 13 in which said interface is configured to identify the source of said mail.

15. The method of claim 13 in which said interface is configured to provide information concerning the contents of said mail.

16. The method of claim 13 in which said interface is configured to proved an image of at least a portion of the contents of said mail.

17. The method of claim 13 in which said interface is configured to provide an image of information associated with said mail.

18. The method of claim 5 in which said entity may provide direct differing types of mail to the same or differing locations.
